(19) United States
(12) Patent Application Publication
(10) Pub. No.: US 2026/0057501 A1
(43) Pub. Date: Feb. 26, 2026

(54) Data Storage Device and Method for Resource Optimization in Video Processing

(71) Applicant: Sandisk Technologies, Inc., Milpitas, CA (US)

(72) Inventors: Ramanathan Muthiah, Bangalore (IN); Vinay Kumar, Bangalore (IN)

(73) Assignee: Sandisk Technologies, Inc., Milpitas, CA (US)

(21) Appl. No.: 18/813,426

(22) Filed: Aug. 23, 2024

(51) Int. Cl. G06T 7/00

(52) U.S. Cl. CPC G06T 7/0002; G06T 2207/30168

(57) ABSTRACT

A data storage device and method are disclosed for resource optimization in video processing. In one embodiment, a data storage device is provided comprising a memory and one or more processors. The one or more processors, individually or in combination, are configured to: determine whether an image frame requires processing; in response to determining that the image frame requires processing: generate a lower-quality version of the image frame; and perform processing on the lower-quality version of the image frame; determine whether additional processing is needed; and in response to determining that additional processing is needed, perform the additional processing on the image frame instead of the lower-quality version of the image frame. Other embodiments are provided.

### BACKGROUND

A data storage device can be used to store image/video data, and workloads can range from high definition (HD) to higher resolutions, such as 4K. A 4K display has a typical resolution of 3840×2160 pixels, which is four times the pixel count of a full HD display (1920×1080 pixels). Frame processing of such a large amount of data often requires a large amount of power consumption for the controller of the data storage device. Additionally, such large files can take a relatively-long time to process in compute surveillance systems. To reduce the required power and time, a higher-resolution image can be converted (downscaled) to a lower-resolution image.

### BRIEF DESCRIPTION OF THE DRAWINGS

FIG. 1A is a block diagram of a data storage device of an embodiment.

FIG. 1B is a block diagram illustrating a storage module of an embodiment.

FIG. 1C is a block diagram illustrating a hierarchical storage system of an embodiment.

FIG. 2A is a block diagram illustrating components of the controller of the data storage device illustrated in FIG. 1A according to an embodiment.

FIG. 2B is a block diagram illustrating components of the data storage device illustrated in FIG. 1A according to an embodiment.

FIG. 3 is a block diagram of a host and a data storage device of an embodiment.

FIG. 4 is a method for resource optimization performed by a data storage device of an embodiment.

FIG. 5 is a method for resource optimization performed by a host of an embodiment.

### DETAILED DESCRIPTION

The following embodiments generally relate to a data storage device and method for resource optimization in video processing. In one embodiment, a data storage device is provided comprising a memory and one or more processors. The one or more processors, individually or in combination, are configured to: determine whether an image frame requires processing; in response to determining that the image frame requires processing: generate a lower-quality version of the image frame; and perform processing on the lower-quality version of the image frame; determine whether additional processing is needed; and in response to determining that additional processing is needed, perform the additional processing on the image frame instead of the lower-quality version of the image frame.

In some embodiments, the one or more processors, individually or in combination, are further configured to store the lower-quality version of the image.

In some embodiments, the one or more processors, individually or in combination, are further configured to use a different memory trim to store the lower-quality version of the image frame than used to store the image frame.

In some embodiments, the area of the memory is chosen based on a data time limit to reduce garbage collection.

In some embodiments, the area of the memory is exposed to a host.

In some embodiments, the area of the memory is not exposed to a host.

In some embodiments, determining whether the image frame requires processing comprises using an entropy threshold.

In some embodiments, the one or more processors, individually or in combination, are further configured to parse the image frame from a video stream.

In some embodiments, the lower-quality version of the image frame is generated using pixel degradation.

In some embodiments, the memory comprises a three-dimensional memory.

In another embodiment, a method is provided that is performed in a host in communication with a data storage device comprising a memory. The method comprises: generating a lower-quality version of an image frame; performing a first-level computation on the lower-quality version of the image frame; determining whether a result of the first-level computation meets a quality-of-service requirement; and in response to determining that the result of the first-level computation does not meet the quality-of-service requirement, performing a second-level computation on the image frame instead of on the lower-quality version of the image frame.

In some embodiments, the method further comprises storing the lower-quality version of the image frame in an area of the memory of the data storage device.

In some embodiments, a different memory trim is used to store the lower-quality version of the image frame than used to store the image frame.

In some embodiments, the area of the memory is chosen based on a data time limit to reduce garbage collection.

In some embodiments, the area of the memory is exposed to a host.

In some embodiments, the method further comprises determining whether the image frame requires processing using an entropy threshold.

In some embodiments, the method further comprises parsing the image frame from a video stream.

In some embodiments, the lower-quality version of the image frame is generated using pixel degradation.

In some embodiments, the memory of the data storage device comprises a three-dimensional memory.

In another embodiment, a data storage device is provided comprising: a memory; and means for: generating a lower-quality version of an image frame; performing processing on the lower-quality version of the image frame; and performing additional processing on the image frame only in response to determining that a result of the processing on the lower-quality version of the image frame does not meet a requirement.

Other embodiments are possible, and each of the embodiments can be used alone or together in combination. Accordingly, various embodiments will now be described with reference to the attached drawings.

### Embodiments

The following embodiments relate to a data storage device (DSD). As used herein, a “data storage device” refers to a non-volatile device that stores data. Examples of DSDs include, but are not limited to, hard disk drives (HDDs), solid state drives (SSDs), tape drives, hybrid drives, etc. Details of example DSDs are provided below.

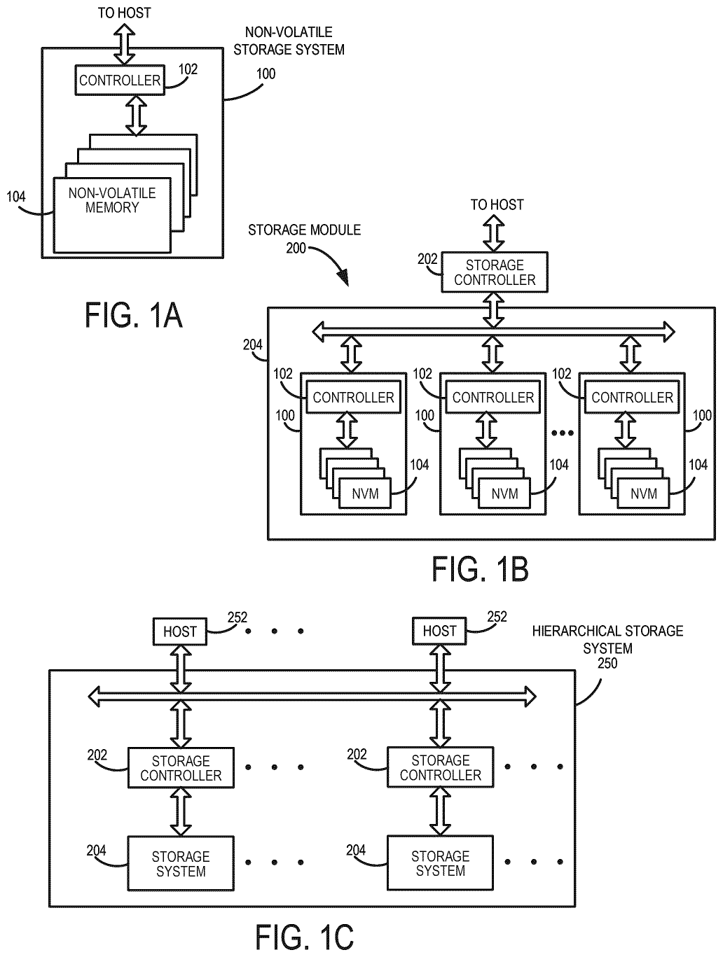

Examples of data storage devices suitable for use in implementing aspects of these embodiments are shown in FIGS. 1A-1C. It should be noted that these are merely examples and that other implementations can be used. FIG. 1A is a block diagram illustrating the data storage device 100 according to an embodiment. Referring to FIG. 1A, the data storage device 100 in this example includes a controller 102 coupled with a non-volatile memory that may be made up of one or more non-volatile memory die 104. As used herein, the term die refers to the collection of non-volatile memory cells, and associated circuitry for managing the physical operation of those non-volatile memory cells, that are formed on a single semiconductor substrate. The controller 102 interfaces with a host system and transmits command sequences for read, program, and erase operations to non-volatile memory die 104. Also, as used herein, the phrase “in communication with” or “coupled with” could mean directly in communication/coupled with or indirectly in communication/coupled with through one or more components, which may or may not be shown or described herein. The communication/coupling can be wired or wireless.

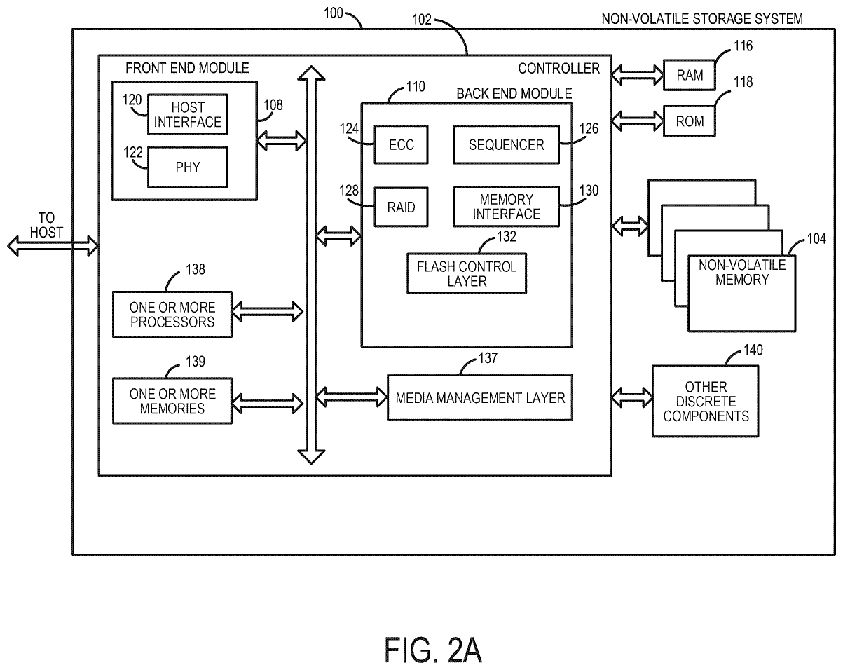

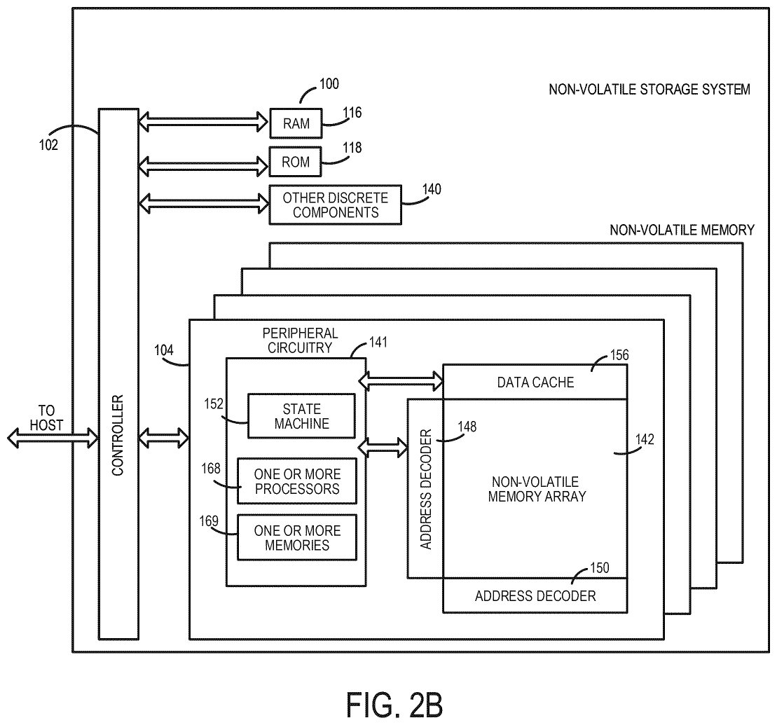

The controller 102 (which may be a non-volatile memory controller (e.g., a flash, resistive random-access memory (ReRAM), phase-change memory (PCM), or magnetoresistive random-access memory (MRAM) controller)) can include one or more components, individually or in combination, configured to perform certain functions, including, but not limited to, the functions described herein and illustrated in the flow charts. For example, as shown in FIG. 2A, the controller 102 can comprise one or more processors 138 that are, individually or in combination, configured to perform functions, such as, but not limited to the functions described herein and illustrated in the flow charts, by executing computer-readable program code stored in one or more non-transitory memories 139 inside the controller 102 and/or outside the controller 102 (e.g., in random access memory (RAM) 116 or read-only memory (ROM) 118). As another example, the one or more components can include circuitry, such as, but not limited to, logic gates, switches, an application specific integrated circuit (ASIC), a programmable logic controller, and an embedded microcontroller.

In one example embodiment, the non-volatile memory controller 102 is a device that manages data stored on non-volatile memory and communicates with a host, such as a computer or electronic device, with any suitable operating system. The non-volatile memory controller 102 can have various functionality in addition to the specific functionality described herein. For example, the non-volatile memory controller can format the non-volatile memory to ensure the memory is operating properly, map out bad non-volatile memory cells, and allocate spare cells to be substituted for future failed cells. Some part of the spare cells can be used to hold firmware (and/or other metadata used for housekeeping and tracking) to operate the non-volatile memory controller and implement other features. In operation, when a host needs to read data from or write data to the non-volatile memory, it can communicate with the non-volatile memory controller. If the host provides a logical address to which data is to be read/written, the non-volatile memory controller can convert the logical address received from the host to a physical address in the non-volatile memory. The non-volatile memory controller can also perform various memory management functions, such as, but not limited to, wear leveling (distributing writes to avoid wearing out specific blocks of memory that would otherwise be repeatedly written to) and garbage collection (after a block is full, moving only the valid pages of data to a new block, so the full block can be erased and reused).

Non-volatile memory die 104 may include any suitable non-volatile storage medium, including resistive random-access memory (ReRAM), magnetoresistive random-access memory (MRAM), phase-change memory (PCM), NAND flash memory cells and/or NOR flash memory cells. The memory cells can take the form of solid-state (e.g., flash) memory cells and can be one-time programmable, few-time programmable, or many-time programmable. The memory cells can also be single-level cells (SLC), multiple-level cells (MLC) (e.g., dual-level cells, triple-level cells (TLC), quad-level cells (QLC), etc.) or use other memory cell level technologies, now known or later developed. Also, the memory cells can be fabricated in a two-dimensional or three-dimensional fashion.

The interface between controller 102 and non-volatile memory die 104 may be any suitable flash interface, such as Toggle Mode 200, 400, or 800. In one embodiment, the data storage device 100 may be a card-based system, such as a secure digital (SD) or a micro secure digital (micro-SD) card. In an alternate embodiment, the data storage device 100 may be part of an embedded data storage device.

Although, in the example illustrated in FIG. 1A, the data storage device 100 (sometimes referred to herein as a storage module) includes a single channel between controller 102 and non-volatile memory die 104, the subject matter described herein is not limited to having a single memory channel. For example, in some architectures (such as the ones shown in FIGS. 1B and 1C), two, four, eight or more memory channels may exist between the controller and the memory device, depending on controller capabilities. In any of the embodiments described herein, more than a single channel may exist between the controller and the memory die, even if a single channel is shown in the drawings.

FIG. 1B illustrates a storage module 200 that includes plural non-volatile data storage devices 100. As such, storage module 200 may include a storage controller 202 that interfaces with a host and with data storage device 204, which includes a plurality of data storage devices 100. The interface between storage controller 202 and data storage devices 100 may be a bus interface, such as a serial advanced technology attachment (SATA), peripheral component interconnect express (PCIe) interface, double-data-rate (DDR) interface, or serial attached small scale compute interface (SAS/SCSI). Storage module 200, in one embodiment, may be a solid-state drive (SSD), or non-volatile dual in-line memory module (NVDIMM), such as found in server PC or portable computing devices, such as laptop computers, and tablet computers.

FIG. 1C is a block diagram illustrating a hierarchical storage system. A hierarchical storage system 250 includes a plurality of storage controllers 202, each of which controls a respective data storage device 204. Host systems 252 may access memories within the storage system 250 via a bus interface. In one embodiment, the bus interface may be a Non-Volatile Memory Express (NVMe) or Fibre Channel over Ethernet (FCoE) interface. In one embodiment, the system illustrated in FIG. 1C may be a rack mountable mass storage system that is accessible by multiple host computers, such as would be found in a data center or other location where mass storage is needed.

Referring again to FIG. 2A, the controller 102 in this example also includes a front-end module 108 that interfaces with a host, a back-end module 110 that interfaces with the one or more non-volatile memory die 104, and various other components or modules, such as, but not limited to, a buffer manager/bus controller module that manage buffers in RAM 116 and controls the internal bus arbitration of controller 102. A module can include one or more processors or components, as discussed above. The ROM 118 can store system boot code. Although illustrated in FIG. 2A as located separately from the controller 102, in other embodiments one or both of the RAM 116 and ROM 118 may be located within the controller 102. In yet other embodiments, portions of RAM 116 and ROM 118 may be located both within the controller 102 and outside the controller 102.

Front-end module 108 includes a host interface 120 and a physical layer interface (PHY) 122 that provide the electrical interface with the host or next level storage controller. The choice of the type of host interface 120 can depend on the type of memory being used. Examples of host interfaces 120 include, but are not limited to, SATA, SATA Express, serially attached small computer system interface (SAS), Fibre Channel, universal serial bus (USB), PCIe, and NVMe. The host interface 120 typically facilitates transfer for data, control signals, and timing signals.

Back-end module 110 includes an error correction code (ECC) engine 124 that encodes the data bytes received from the host, and decodes and error corrects the data bytes read from the non-volatile memory. A command sequencer 126 generates command sequences, such as program and erase command sequences, to be transmitted to non-volatile memory die 104. A RAID (Redundant Array of Independent Drives) module 128 manages generation of RAID parity and recovery of failed data. The RAID parity may be used as an additional level of integrity protection for the data being written into the memory device 104. In some cases, the RAID module 128 may be a part of the ECC engine 124. A memory interface 130 provides the command sequences to non-volatile memory die 104 and receives status information from non-volatile memory die 104. In one embodiment, memory interface 130 may be a double data rate (DDR) interface, such as a Toggle Mode 200, 400, or 800 interface. The controller 102 in this example also comprises a media management layer 137 and a flash control layer 132, which controls the overall operation of back-end module 110.

The data storage device 100 also includes other discrete components 140, such as external electrical interfaces, external RAM, resistors, capacitors, or other components that may interface with controller 102. In alternative embodiments, one or more of the physical layer interface 122, RAID module 128, media management layer 138 and buffer management/bus controller are optional components that are not necessary in the controller 102.

FIG. 2B is a block diagram illustrating components of non-volatile memory die 104 in more detail. Non-volatile memory die 104 includes peripheral circuitry 141 and non-volatile memory array 142. Non-volatile memory array 142 includes the non-volatile memory cells used to store data. The non-volatile memory cells may be any suitable non-volatile memory cells, including ReRAM, MRAM, PCM, NAND flash memory cells and/or NOR flash memory cells in a two-dimensional and/or three-dimensional configuration. Non-volatile memory die 104 further includes a data cache 156 that caches data and address decoders 148, 150. The peripheral circuitry 141 in this example includes a state machine 152 that provides status information to the controller 102. The peripheral circuitry 141 can also comprise one or more components that are, individually or in combination, configured to perform certain functions, including, but not limited to, the functions described herein and illustrated in the flow charts. For example, as shown in FIG. 2B, the memory die 104 can comprise one or more processors 168 that are, individually or in combination, configured to execute computer-readable program code stored in one or more non-transitory memories 169, stored in the memory array 142, or stored outside the memory die 104. As another example, the one or more components can include circuitry, such as, but not limited to, logic gates, switches, an application specific integrated circuit (ASIC), a programmable logic controller, and an embedded microcontroller.

In addition to or instead of the one or more processors 138 (or, more generally, components) in the controller 102 and the one or more processors 168 (or, more generally, components) in the memory die 104, the data storage device 100 can comprise another set of one or more processors (or, more generally, components). In general, wherever they are located and however many there are, one or more processors (or, more generally, components) in the data storage device 100 can be, individually or in combination, configured to perform various functions, including, but not limited to, the functions described herein and illustrated in the flow charts. For example, the one or more processors (or components) can be in the controller 102, memory device 104, and/or other location in the data storage device 100. Also, different functions can be performed using different processors (or components) or combinations of processors (or components). Further, means for performing a function can be implemented with a controller comprising one or more components (e.g., processors or the other components described above).

Returning again to FIG. 2A, the flash control layer 132 (which will be referred to herein as the flash translation layer (FTL) handles flash errors and interfaces with the host. In particular, the FTL, which may be an algorithm in firmware, is responsible for the internals of memory management and translates writes from the host into writes to the memory 104. The FTL may be needed because the memory 104 may have limited endurance, may be written in only multiples of pages, and/or may not be written unless it is erased as a block. The FTL understands these potential limitations of the memory 104, which may not be visible to the host. Accordingly, the FTL attempts to translate the writes from host into writes into the memory 104.

The FTL may include a logical-to-physical address (L2P) map (sometimes referred to herein as a table or data structure) and allotted cache memory. In this way, the FTL translates logical block addresses (“LBAs”) from the host to physical addresses in the memory 104. The FTL can include other features, such as, but not limited to, power-off recovery (so that the data structures of the FTL can be recovered in the event of a sudden power loss) and wear leveling (so that the wear across memory blocks is even to prevent certain blocks from excessive wear, which would result in a greater chance of failure).

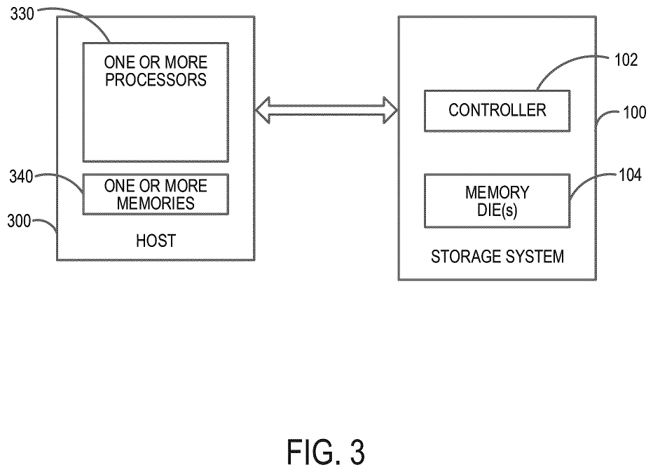

Turning again to the drawings, FIG. 3 is a block diagram of a host 300 and data storage device 100 of an embodiment. The host 300 can take any suitable form, including, but not limited to, a computer, a mobile phone, a tablet, a wearable device, a digital video recorder, a surveillance system, etc. The host 300 in this embodiment (here, a computing device) comprises one or more processors 330 and one or more memories 340. In one embodiment, computer-readable program code stored in the one or more memories 340 configures the one or more processors 330 to perform the acts described herein as being performed by the host 300. So, actions performed by the host 300 are sometimes referred to herein as being performed by an application (computer-readable program code) run on the host 300. For example, the host 300 can be configured to send data (e.g., initially stored in the host's memory 340) to the data storage device 100 for storage in the data storage device's memory 104.

As mentioned above, a data storage device can be used to store image/video data, and workloads can range from high definition (HD) to higher resolutions, such as 4K. A 4K display has a typical resolution of 3840×2160 pixels, which is four times the pixel count of a full HD display (1920×1080 pixels). Frame processing of such a large amount of data often requires a large amount of power consumption for the controller of the data storage device. Additionally, such large files can take a relatively-long time to process in compute surveillance systems. To reduce the required power and time, a higher-resolution image/video can be converted (downscaled) to a lower-resolution image/video. Downscaling is typically a much-simpler process than upscaling, and there are several ways to do it with varying levels of complexity. While a low-resolution image can be advantageous for compute cores and can take less time and resources for processing, if there is a need to perform a high-precision computation, there is a loss of information due to the low resolution.

The following embodiments can be used to provide a middle ground to solve both the resolution problem and reduce the compute power/resources and time taken by the processing cores that process image/video data. Such processing cores are in a data storage device in some embodiments and in a host in other embodiments.

In one embodiment, the controller 102 of the data storage device 100 parses a surveillance video stream, and on determining that one or more video frames needs post-processing, the controller 102 generates a lower-quality version of the same video frame(s) (or an image) and performs further computations and video processing on the generated low-pixel image until its logic determines that subsequent high-resolution processing is also required for completion, thereby saving compute power and processing resources while processing most of the frames most of the time. In one embodiment, the controller 102 determines that a video frame needs post-processing when an event is detected. For example, the event can be an object (e.g., person or vehicle) entering an area under surveillance based on an entropy threshold (e.g., a change in a number of pixels form one image to another).

The controller 102 can store such pseudo-duplicate data of low-quality or lower pixels that it generated as intermediate compute data in a device-specific block in the memory 104 that is not exposed to the host 300. The controller 102 can alternatively and additionally use the generated low-resolution data for further compute requirements in the system. The controller 102 (e.g., the flash translation layer (FTL) can be configured to use a different memory trim (e.g., NAND program voltage and program time and/or retrieval voltage and time) for the intermediate data based on endurance and/or protection requirements. The controller 102 can additionally group and route the lower-pixel quality image to unique logical blocks based on a data time limit (lifetime) requirements to ease garbage collection later.

In some cases, the device-generated version of lower quality data is stored as another logical data transparent to the host 300 (secondary data set), and both the host 300 and the data storage device 100 can leverage this intermediate data set for quick and approximate computations in the first phase. For example, if the approximate processing is not sufficient, it can subsequently take up computations on the default data that involves high-resolution pixel processing in an image. In some cases, the controller 102 performs secondary processing only on the default data when the results of the first stage are promising. Likewise, multiple system scenarios can be addressed.

In some cases, the host 300 or data storage device 100 can use the secondary data set as redundant array of independent drives (RAID) data of the actual data set. In this way, on a memory failure in the high-pixel data set, the data storage device 100 can use the low-pixel redundant data as a fast and graceful recovery mechanism.

It may be noted that the computation on an image with lower pixels is power and resource optimal as compared to a computation on an image with higher pixel order. Further, simple degradation is low power and resource efficient compared to the advantages gained by these embodiments.

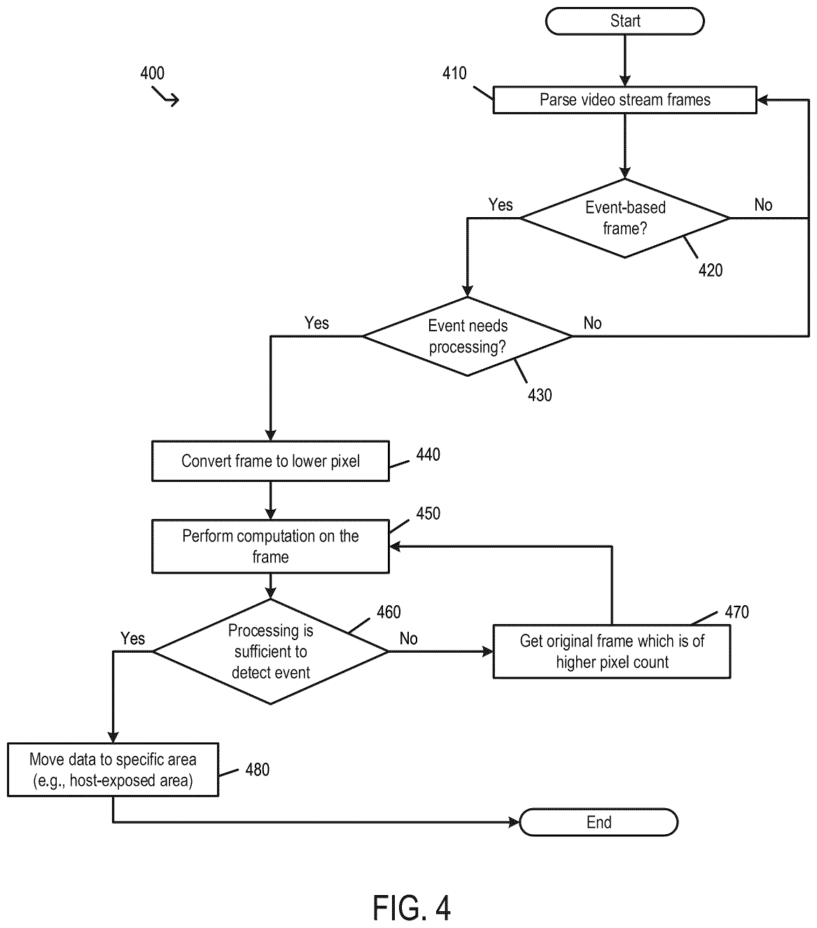

Turning now to the drawings, FIG. 4 is a flow chart 400 of a method for resource optimization performed by the data storage device 100 of this embodiment. As shown in FIG. 4, in this embodiment, the controller 102 of the data storage device 100 parses video stream frames (410) and determines if a frame is an event-based frame (420) (e.g., using an entropy threshold to determine if an object entered the field of view under surveillance). If the frame is not an event-based frame, the method loops back to 410. However, if the frame is an event-based frame, the controller 102 determines if the event needs processing (430) (e.g., to more clearly see an object that entered the field of view). If the event does not need processing, the method loops back to 410. However, if the event does need processing, the controller 102 converts the frame to a lower-pixel version of the frame (440) and performs a computation on the frame (450). Next, the controller 102 determines if the processing is sufficient to detect the event (460). If the processing is not sufficient to detect the event, the controller 102 gets the original frame, which is of a higher pixel count, (470) and performs the computation on that higher-pixel version of the frame (450). However, if the processing is sufficient to detect the event, the controller 102 moves the data to a specific area in the memory 104 (e.g., a host-exposed area) (480), and the method ends.

In an alternate embodiment, this method can be performed in the host 300 (e.g., that manages surveillance storage) instead of the data storage device 100. In this embodiment, the one or more processors 330 in the host 300 can be configured, individually or in combination, to manage surveillance data, determine that a data set associated with the surveillance module needs video processing, extract the corresponding video frames, generate a lower quality of the frame that has fewer pixels than the original, and perform first-level computation on the new image to save at least one of compute power and compute resources. On further determining that the compute precision of the output is not consistent with the required compute quality of service (QoS), the one or more processors 330 in the host 300 can follow up with performing another processing of the original video frame (default quality with more pixel), thereby spending more compute power and resources only for the required candidate frames. The one or more processors 330 in the host 300 can optionally store the lower-quality frames in the data storage device 100 as a secondary dataset targeted for high speed and approximate computations. The computations on lower-quality data enables the host 300 to use fewer resources and less power that initially estimated.

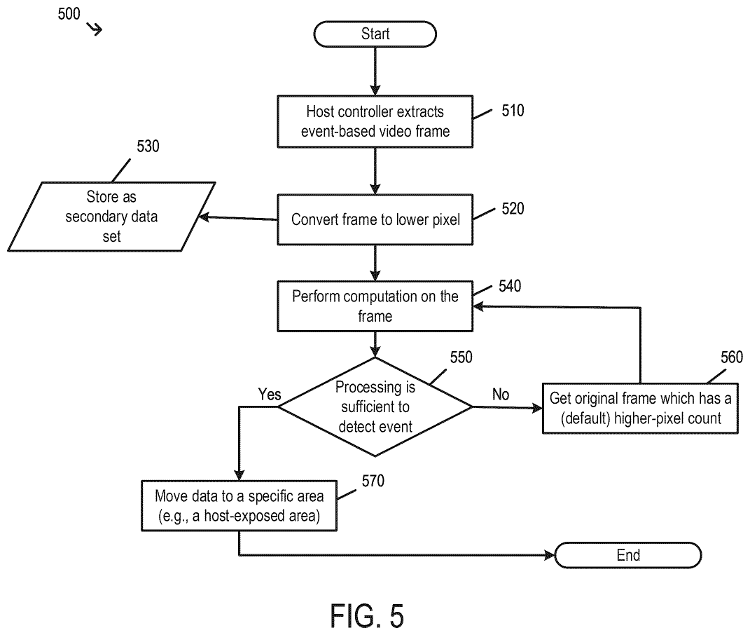

FIG. 5 is a flow chart 500 of an example host-side implementation. As shown in FIG. 5, the one or more processors 330 in the host 300 (referred to here as the “host controller”) extracts an event-based video frame from a video stream (510) and converts the frame to a lower-pixel version (520). The host controller can optionally store the lower-pixel version as a secondary data set in the data storage device (530). Next, the host controller performs a computation on the frame (540) and determines if processing is sufficient to detect the event (550). If the processing is not sufficient to detect the event, the host controller gets the original frame, which is of a (default) higher-pixel count, (560) and performs processing on that frame (540). However, if processing is sufficient to detect the event, the host controller moves the data to a specific area in the memory 104 (e.g., a host-exposed area) (570), and the method ends.

Additionally and independently, based on an entropy threshold level of various frames in the video stream, the controller 102 in the data storage device 100 and/or the host controller 330 can have a policy that states that some of the frames undergo conditional two-stage processing, and other frames undergo only a first optimal stage of low-pixel computation, and yet other frames directly undergo power-intensive computations on the default data set itself. The system resources and the power constraints in the system can be used as another parameter alongside entropy of the video frames to determine which of the frames undergo or skip any of the stages.

It may be noted that it is relatively easy to convert an image of higher resolution to lower resolution. This is a much-simpler process than the opposite (upscaling), and there are several ways to do it with varying levels of complexity. As a simple example, basic degradation involves dropping some pixels which leads to loss of detail, but it may still be sufficient to determine basic processing, such as “detect a red car” in a video frame. Known complex methods include resampling algorithms which have a different downscale process. To summarize, the overall power and resources required to perform degradation in these embodiments is far less as compared to what is gained from the flow. By cautiously spending power and resources for candidates that need more compute precision, the host 300 and/or data storage device 100 can save power in a video storage environment. The controller 102 can maintain an entropy threshold and a pixel degradation threshold for optimal processing of video/image frames in a system.

The embodiments described herein can be used to optimize power and resources in any suitable type of surveillance system, such as, for example, those described in U.S. Pat. No. 11,562,018 and U.S. patent application Ser. No. 18/364,740, both of which are hereby incorporated by reference herein.

In one use case described in the '018 patent, the data storage device can parse video frames in a logical range such that it can match those frames with a target and generate a matching number. In such a use case, the data storage device uses the embodiments presented herein to perform two level of matches, where the controller can degrade the quality of instantaneous decoding refresh (IDR) frames (e.g., using a pixel drop), perform a first level of matching on the lower-quality frame, and on determining that the match result is more than a threshold, perform a second level of match on the default, high-pixel data as a concluding step. Such a matching mechanism saves processing power.

In one use case described in the '740 application, once a camera has detected an event, it sends information to a neighborhood system as a heads up to enhance the capture capability of multiple cameras. The embodiments described herein can be used in such a system, whereby when a surveillance node detects an event that needs processing by another node, it provides a heads up to the neighborhood system, and the system is set-up to make an adjustment to capture the upcoming events in high-quality mode. However, the controller processes such high-quality data in at least two steps. In the first step, it purposefully degrades the quality of the captured frame prior to performing computations, and, only on determining that the results are aligned to the expectation, it performs a processing on the default high-quality frame data.

Finally, as mentioned above, any suitable type of memory can be used. Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are examples, and memory elements may be otherwise configured.

The semiconductor memory elements located within and/or over a substrate may be arranged in two or three dimensions, such as a two-dimensional memory structure or a three-dimensional memory structure.

In a two-dimensional memory structure, the semiconductor memory elements are arranged in a single plane or a single memory device level. Typically, in a two-dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and wordlines.

A three-dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three-dimensional memory structure may be vertically arranged as a stack of multiple two-dimensional memory device levels. As another non-limiting example, a three-dimensional memory array may be arranged as multiple vertical columns (e.g., columns extending substantially perpendicular to the major surface of the substrate, i.e., in the y direction) with each column having multiple memory elements in each column. The columns may be arranged in a two-dimensional configuration, e.g., in an x-z plane, resulting in a three-dimensional arrangement of memory elements with elements on multiple vertically stacked memory planes. Other configurations of memory elements in three dimensions can also constitute a three-dimensional memory array.

By way of non-limiting example, in a three-dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three-dimensional configurations can be envisioned wherein some NAND strings contain memory elements in a single memory level while other strings contain memory elements which span through multiple memory levels. Three-dimensional memory arrays may also be designed in a NOR configuration and in a ReRAM configuration.

Typically, in a monolithic three-dimensional memory array, one or more memory device levels are formed above a single substrate. Optionally, the monolithic three-dimensional memory array may also have one or more memory layers at least partially within the single substrate. As a non-limiting example, the substrate may include a semiconductor such as silicon. In a monolithic three-dimensional array, the layers constituting each memory device level of the array are typically formed on the layers of the underlying memory device levels of the array. However, layers of adjacent memory device levels of a monolithic three-dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three-dimensional memory arrays. Further, multiple two-dimensional memory arrays or three-dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two dimensional and three-dimensional structures described but cover all relevant memory structures within the spirit and scope of the invention as described herein and as understood by one of skill in the art.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the embodiments described herein can be used alone or in combination with one another.

What is claimed is:

1. A data storage device comprising:
a memory; and
one or more processors, individually or in combination, configured to:
determine whether an image frame requires processing;
in response to determining that the image frame requires processing:
generate a lower-quality version of the image frame; and
perform processing on the lower-quality version of the image frame;
determine whether additional processing is needed; and
in response to determining that additional processing is needed, perform the additional processing on the image frame instead of the lower-quality version of the image frame.

2. The data storage device of claim 1, wherein the one or more processors, individually or in combination, are further configured to store the lower-quality version of the image frame.

3. The data storage device of claim 2, wherein the one or more processors, individually or in combination, are further configured to use a different memory trim to store the lower-quality version of the image frame than used to store the image frame.

4. The data storage device of claim 2, wherein the area of the memory is chosen based on a data time limit to reduce garbage collection.

5. The data storage device of claim 1, wherein the area of the memory is exposed to a host.

6. The data storage device of claim 1, wherein the area of the memory is not exposed to a host.

7. The data storage device of claim 1, wherein determining whether the image frame requires processing comprises using an entropy threshold.

8. The data storage device of claim 1, wherein the one or more processors, individually or in combination, are further configured to parse the image frame from a video stream.

9. The data storage device of claim 1, wherein the lower-quality version of the image frame is generated using pixel degradation.

10. The data storage device of claim 1, wherein the memory comprises a three-dimensional memory.

11. A method comprising:
performing in a host in communication with a data storage device comprising a memory:
generating a lower-quality version of an image frame;
performing a first-level computation on the lower-quality version of the image frame;
determining whether a result of the first-level computation meets a quality-of-service requirement; and
in response to determining that the result of the first-level computation does not meet the quality-of-service requirement, performing a second-level computation on the image frame instead of on the lower-quality version of the image frame.

12. The method of claim 11, further comprising storing the lower-quality version of the image frame in an area of the memory of the data storage device.

13. The method of claim 12, wherein a different memory trim is used to store the lower-quality version of the image frame than used to store the image frame.

14. The method of claim 12, wherein the area of the memory is chosen based on a data time limit to reduce garbage collection.

15. The method of claim 12, wherein the area of the memory is exposed to a host.

16. The method of claim 11, further comprising determining whether the image frame requires processing using an entropy threshold.

17. The method of claim 11, further comprising parsing the image frame from a video stream.

18. The method of claim 11, wherein the lower-quality version of the image frame is generated using pixel degradation.

19. The method of claim 11, wherein the memory of the data storage device comprises a three-dimensional memory.

20. A data storage device comprising:
a memory; and
means for:
generating a lower-quality version of an image frame;
performing processing on the lower-quality version of the image frame; and
performing additional processing on the image frame only in response to determining that a result of the processing on the lower-quality version of the image frame does not meet a requirement.
